(19) United States
(12) Patent Application Publication
(10) Pub. No.: US 2021/0182749 A1
(43) Pub. Date: Jun. 17, 2021

(54) METHOD OF PREDICTING COMPONENT FAILURE IN DRIVE TRAIN ASSEMBLY OF WIND TURBINES

(71) Applicant: DT360 INC., Natick, MA (US)

(72) Inventors: Sivarama Krishnan Balasubramanian, Chennai (IN); Krishna Paracharan Srinivasaraghavan, Chennai (IN); Ganapathy Subramanium Sundar Ramaswamy, Chennai (IN); Mirra Amritha, Chennai (IN); Rajasekaran Panchatcharam, Chennai (IN)

(73) Assignee: DT360 INC., Natick, MA (US)

(21) Appl. No.: 17/157,412

(22) Filed: Jan. 25, 2021

Related U.S. Application Data
(63) Continuation-in-part of application No. 16/389,493, filed on Apr. 19, 2019, now Pat. No. 10,902,368.
Application No. 16/389,493 is a continuation-in-part of application No. 15/921,456, filed on Mar. 14, 2018, now abandoned.
Application No. 15/921,456 is a continuation of application No. 14/205,377, filed on Mar. 12, 2014, now abandoned.

(51) Int. Cl. G06Q 10/06

(52) U.S. Cl. CPC G06Q 10/0635; G06Q 10/067; G06Q 10/0637

(57) ABSTRACT

A method for predicting component failure in a drive train assembly of a wind turbine comprises acquiring data from a plurality of wind turbine sensors pertaining to one or more components of the drive train assembly. The data is fed into one or more RETINA remote nodes and is filtering and aggregating into time intervals. The data is archived in a centralized data-warehouse and is used to build a machine learning model configured to determine ideal temperatures of components in the drive train assembly. The ideal temperatures are compared to actual measured temperatures in order to determine one or more temperature deviations. The one or more temperature deviations are used to determine a severity index score. An alert is generated corresponding to a high severity index score, wherein the alert informs of a likely imminent component failure.

### CROSS-REFERENCE TO RELATED APPLICATIONS

This application is a continuation-in-part of, and claims the benefit and priority of U.S. patent application Ser. No. 16/389,493, filed on Apr. 19, 2019, which is a continuation-in-part of U.S. patent application Ser. No. 15/921,456, filed on Mar. 14, 2018, which is a continuation of U.S. patent application Ser. No. 14/205,377, filed on Mar. 12, 2014. The entire contents of such applications are incorporated herein by reference.

### FIELD OF THE INVENTION

The present invention relates to a method for estimating the probability of component failure in a wind turbine, and more specifically the a method using RETINA (Real time Integration and Analytics) software to analyze the impact analysis key components of the wind turbine which contribute to the health score of the equipment, which is used to estimate the probability of failure for components in the drive-train of a wind turbine, such as the gear box and generator of the wind turbine. The disclosed method further considers the component's behavior in the past comprising different operating conditions and compares its current performance against itself and tries to estimate/simulate its expected behavior in the near future. Based on this estimate, it then tries to detect those components which exhibit anomalies from the expected behavior and flags them for preplanned maintenance, which leads to an overall reduction in unplanned downtime.

### BACKGROUND OF THE INVENTION AND PRIOR ART

Rotating equipment such as motor drives, pumps, compressors, turbines, blowers, fans, generators, and gear boxes are used spanning multiple industries and verticals. Although such components are designed for long-term continual usage, they still exhibit a high proclivity to persistent wear and tear caused by mechanical and thermal stress. This wear and tear results in a reduction in the operational efficiency of the component over time and exposes the individual component a to a high risk of failure, which leads to a breakdown of the device or asset comprising the individual component. Such unplanned breakdowns impact business revenue significantly and can also reduce the overall life of the asset. For instance, the downtime of a wind turbine due to a gear box failure would prevent the generation of electric energy. The impact of this downtime may be significant if it occurs during a time when windy conditions are prevalent.

U.S. Pat. No. 10,752,84462 to Van de Cotte et al. discloses a real time support apparatus, method, and system for facilitating process improvement in petrochemical industries. However, this reference claims to only provide recommendations for process improvement without a clear indication as how these recommendations are derived.

U.S. Pat. No. 9,845,01262 to Lu et al., discloses a method to predict mechanical failures of a rotor by providing a local intelligence system in communication with the motors along and a local dashboard to monitor the predictions and alerts generated by the system. The method attempts to predict mechanical failures of a rotor by comparing the performance of an individual connected motor with similar connected motors alone to detect whether there is a problem with the motor. However, this method does not use the past historical data of the rotor (asset equipment) to model a digital black box model of the rotational equipment which would provide more accurate insights about the asset equipment.

Chinese Patent, CN103033362B, discloses a method to predict the failures in gear systems through multivariate fault pattern detection by using the vibration signal of the equipment and then utilize a machine learning algorithm like support vector regression to predict any probable failure of the equipment in the near future. However, it is difficult to obtain vibration data from industrial rotational equipment due to a lack of instrumentation capabilities to measure such near real-time signals.

These are just some of the disadvantages with current methods used to predict mechanical failure in industrial equipment.

### SUMMARY OF THE INVENTION

An embodiment of a method for detecting anomalies and possible failures in the drive train of wind turbines in a pre-emptive manner is provided. The method uses an algorithm to help reduce the operational risks associated with unplanned downtimes and asset failures caused due to wear and tear and eventual breakdown of mechanical components that make up these assets in a wind farm.

An embodiment of a system for detecting anomalies and possible failures in the drive train of wind turbines in a pre-emptive manner comprises an algorithm to reduce the operational risks associated with unplanned downtimes and asset failures caused due to wear and tear and eventual breakdown of mechanical components that make up these assets in a wind farm.

In an embodiment, data is obtained from sensors connected to the equipment and aggregated using established industrial systems like SCADA, ERP and EAM systems. The data is archived in a centralized data ware-house deployed in the corporate infrastructure or cloud and then the data is utilized to detect anomalies in the operations of the rotational equipment.

In an embodiment, standardized data plumbing and data pre-processing techniques are used to clean up the archived data and create a dataset that can be used to model the ideal operations of a rotational equipment like a wind turbine. The curated dataset is then fed to a machine learning model to detect the ideal temperatures of the components experiencing thermal stress in the device or asset. This is compared against the actual measured component temperatures and the deviations are scored to provide an estimate or probability of failure of an asset component, which may in turn lead to a potential downtime so that said component may be repaired.

In an embodiment, the historical operations of the wind turbines are used to determine a “severity index” value, i.e., a value which indicates how poorly an asset has been performing in the recent history. This may be achieved by comparing the component temperatures against a set/earmarked reference period and then aggregating the normalized deviations across all the component temperatures.

In an embodiment, a method for predicting component failure in a drive train assembly of a wind turbine comprises acquiring data from a plurality of wind turbine sensors pertaining to one or more components of the drive train assembly. The data is fed into one or more RETINA remote nodes where the data is filtered and aggregating the data into time intervals. The data is may then be archived in a centralized data-warehouse. Data points corresponding to intervals when the wind turbine was operating in a curtailed state based on the statistical parameters are identified and removed. This data is then used to build a machine learning model configured to determine ideal temperatures of components in the drive train assembly. The ideal temperatures are compared to actual temperatures to determine one or more temperature deviations, which are used to determine a severity index score. An alert is generated when a high severity index score is detected, wherein the alert informs of a likely imminent component failure.

In an embodiment, a system is provided for predicting failure in components in a drive train of a wind turbine. The system is configured to acquire data from a plurality of wind turbine sensors pertaining to one or more components of the drive train assembly, feeding the data into one or more RETINA remote nodes, filter and aggregate the data into time intervals, and archive the data in a centralized data-warehouse. The system is then configured to identify and remove data points corresponding to intervals when the wind turbine was operating in a curtailed state based on the statistical parameters. The system then uses the data to build a machine learning model configured to determine ideal temperatures of components in the drive train assembly and compares the ideal temperatures to actual temperatures in order to determine one or more temperature deviations. The system uses the one or more temperature deviations to determine a severity index score, and generates an alert corresponding to a high severity index score to inform an operator of a likely imminent component failure.

In an embodiment, one or more of the system components including the RETINA remote nodes, SCADA components, and sensors are in electrical communication with each other and may be configured for bi-directional communication.

### BRIEF DESCRIPTION OF THE DRAWINGS

FIGS. 1A and 1B illustrate an embodiment of a high level block diagram of the various components and engines that make up the system that is used for predicting the anomalies and possible failures in wind turbines.

FIG. 2 illustrates a flow chart depicting an example of the logic for identifying and filtering data points that indicate the turbine is curtailed or derated.

FIG. 3 illustrates a flow chart depicting an example of the logic for identifying and filtering data points that indicate the turbine is operating under low efficiency.

FIG. 4 is a heatmap illustrating an example of the correlation patterns between the key critical parameters used to monitor the performance of a rotational equipment.

FIG. 5 illustrates a flowchart depicting an example of the sequence of steps to be followed for training the ideal “black box model” for the asset.

FIG. 5A illustrates an embodiment of a flowchart designer implementing the flow chart of FIGS. 1, 2 and 4 in RETINA's KPI and Decision Synchronization Configuration platform.

FIG. 5B illustrates an example of a configuration of the random forest algorithm for FIG. 5.

FIG. 5C illustrates an example of a configuration of the filters to identify derating conditions in a wind turbine.

FIG. 5D illustrates an example of a configuration of the alert logic for determining anomalies in the operations of the asset.

FIG. 6 illustrates a flow chart of an embodiment of alert logic for determining anomalies in the operations of the asset.

FIGS. 7A and 7B illustrates sample trends of the deviations in the gearbox temperature and gearbox bearing temperature vs the daily efficiency of the wind turbine, respectively.

FIG. 7C illustrates sample trends of the deviations in the generator temperature vs the daily efficiency of the wind turbine.

### DEFINITIONS

RETINA is a patented software that enables proactive decision synchronization in real time in order to minimize the operational risk and maximize the process productivity for process industries.

Supervisory Control and Data Acquisition (SCADA) is a control system architecture comprising computers, networked data communications and graphical user interfaces for high-level process management.

A decision synchronization is used throughout the foregoing disclosure to refer to a timely and most appropriate recommendation or call-to-action or suggestions from this invention that would be applicable to various business users and applicable to various business areas such that the decisions that are identified by the invention reaches the correct stakeholders for completion or execution.

Mean Absolute Percentage Error (MAPE) is computed as the error or difference between a parameter that is measured in real-time and a parameter that is estimated or predicted using a mathematical model. The MAPE is computed in percentage as (Actual Value of Parameter−Estimated Value of Parameter)/(Actual Value of Parameter).

Condition Monitoring Systems (CMS) as referred to herein are used in asset based industries including wind turbine farms to monitor the condition of assets through measurement of parameters like mechanical vibrations and component temperatures indicative of a potential fault within these assets.

Fast Fourier Transform (FFT) as used herein refers to an algorithm through which data from a parameter/signal can be decomposed to analyze how frequently the signal changes along with any possible scenarios of periodicity.

### DETAILED DESCRIPTION OF THE INVENTION

Wind turbines have become a prominent source of clean and renewable energy nowadays through mechanical coupling and transmission of energy contained in wind to an electrical generator through a rotor and a gear box transmission assembly. This drive train and gear-box assembly is subjected to constant mechanical and thermal stress and hence experiences continuous wear and tear. The prolonged damage caused as a result of the wear and tear, if undetected, can lead to unexpected equipment failure and long downtimes which in turn can hamper the productivity and throughput of the asset.

The disclosed methods and apparatus enable proactive detection of developing problems in the drive-train of wind turbines well ahead of the actual asset failure by using critical component temperatures that define the health of the assets, such as gearbox bearing temperature and generator winding temperature. The disclosed methods and device would be incredibly useful for operations and maintenance personnel because they would assist in preventive/pro-active maintenance and thereby reduce the risk of asset unavailability to improve overall asset reliability. A key requirement in such cases is the proper feedback from the operations and maintenance teams on the state of the asset in question for which the asset risk is dropping. These individuals would need to further validate the reasons as provided by the data models as well as provision the models to update in case of a diagnosis where in the output of the model is proven false.

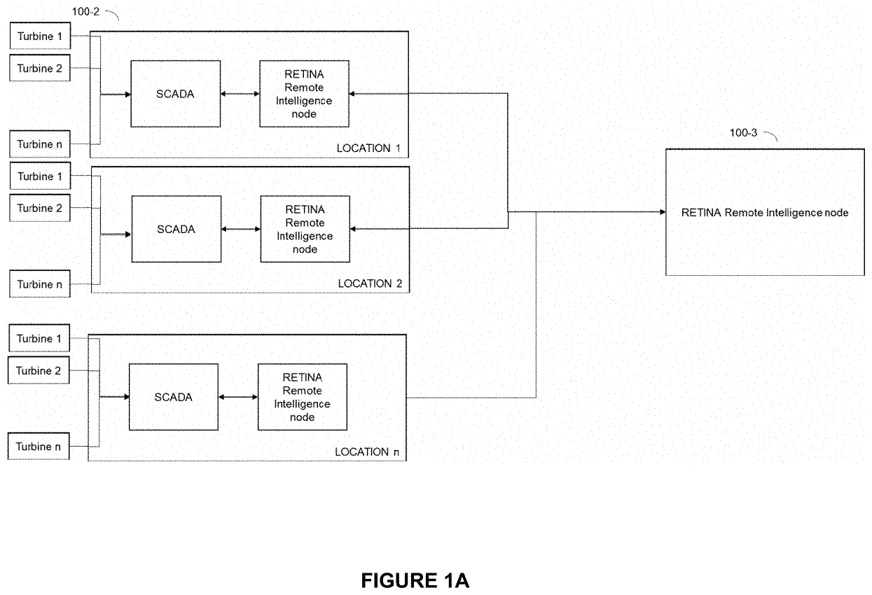

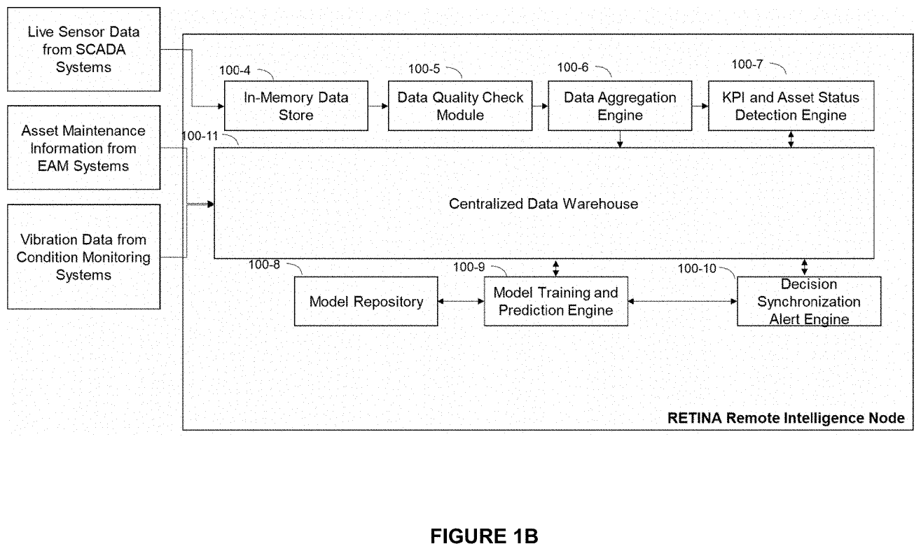

Wind turbines include a wide variety of sensors which measure a multitude of parameters of wind turbine components, such as the speed of the wind hitting the nacelle, ambient temperature, and temperatures of critical components that make up the turbine. Data is acquired from these sensors across multiple turbines in a wind farm and is archived briefly by industrial SCADA systems. FIG. 1A shows a sample layout of how data may be acquired from the sensors of wind turbines and fed to RETINA's remote node. By deploying RETINA remote nodes, the data is read from the SCADA systems and field sensors at time intervals of 1-30 s (100-2). The incoming streaming data is then cleansed using the following steps:
a) Each data point from the SCADA system is checked to see whether the incoming values are acceptable, good, or bad based on the permissible range of values for each of the parameters configured within the SCADA system. Bad values are automatically rejected from the RETINA system to prevent unnecessary data transmission; and
b) Each parameter in the incoming streaming data is configured in the RETINA remote node to have permissible minimum and maximum level. If the incoming data exceeds these levels, the data is clipped to the specified boundary conditions.

As is shown in FIG. 1B, once the data streams into the RETINA node, the data is first pushed to an in-memory data store (100-4) which determines key performance indicators (KPI) like efficiency and turbine status in real time. It has been observed that in live industrial asset based systems, data variability is not high and can be considered to change in every 10 minutes. Thus, rather than storing the data that is streaming in from the RETINA remote node once every 10 seconds, the following data processing steps are applied to optimize the data that is required to be archived into RETINA's data ware-house. Still referring to FIG. 1B, the incoming data is first archived into a temporary non-RETINA data store through RETINA's data import and integration module. From there, the data is first checked for repetitiveness and quality through the data quality check module (100-5). Invalid and bad quality records are filtered and removed from the store.

The remainder of the dataset is then aggregated into 5 minute/10 minute intervals (100-6) for which several data statistics are determined. In an embodiment, the following statistics of the parameters may be determined:
Mean-average of all the values of a parameter within the interval;
Minimum value of all parameters within the interval;
Max value of all parameters within the interval;
Median value of all parameters within the interval;
Standard deviation of all values of parameters within the interval; and
Mode or the most frequently occurring value of parameters within the interval.
   The resulting data set from the above step is then pushed into RETINA's Consolidated Unified Data Archival Block (100-11) where it is then available to be processed/used by the decision synchronizer to predict the component temperature deviations.

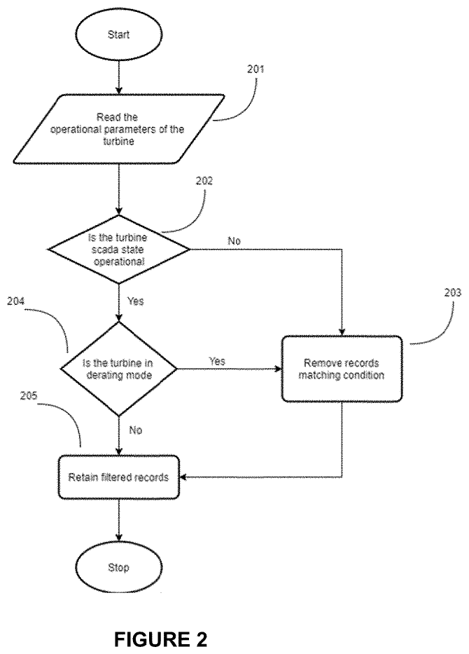

A crucial step to estimate the deviations in the behaviour of the wind turbines is removing the outliers/time periods when the turbine was operating abnormally due to external factors like curtailment, derating, or component failures other than those of the drive-train. These conditions are apparent from the signals obtained from the SCADA systems indicating the turbine status. FIG. 2 describes the flow chart depicting an example of the logic that may be used to identify and filter data points when the turbine is either derated or curtailed. As a first step indicated by (201), the operational parameters such as the status of the turbine indicated in the SCADA system, signals indicating whether the turbine is working in a normal or derated mode, active power generated by the wind turbine, and the measured speed of the wind hitting the turbine are extracted from the centralized data warehouse for any given period of analysis. The disclosed method may use at least 1-2 years of archived historical data to account for all wind variability patterns for data modelling purposes. The data conditions are checked to identify the data points corresponding to when the turbine is either considered to be operational or is not in a curtailed state (202, 204). Data points that match these criteria are then archived into a temporary data store (205) and data points that do not are removed (203).

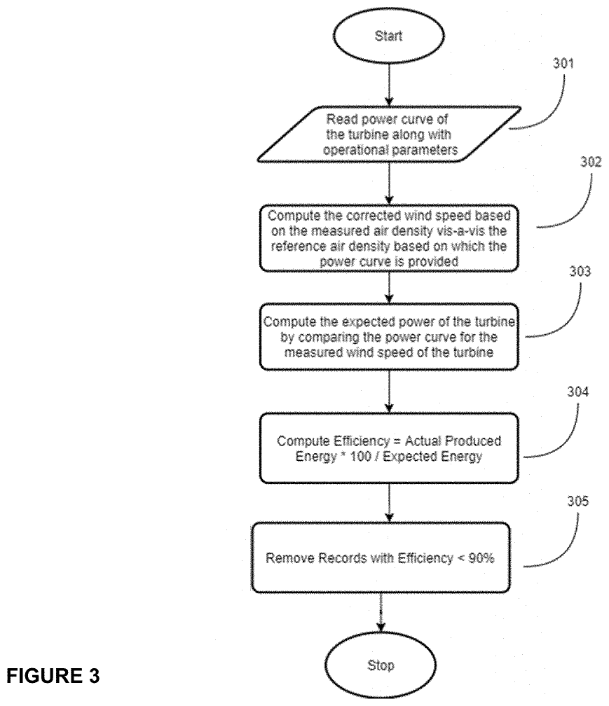

There also may be scenarios where the overall turbine efficiency may be reduced due to other operational problems in turbines. These data points also need to be dropped to fairly estimate the ideal operating condition of the turbines. Turning to FIG. 3, in order to estimate the overall turbine efficiency, first the expected energy of the turbine is determined based on the power curve that is provided by the manufacturer of the turbine (302, 303). Next, the dataset is filtered where the efficiency is less than a desired threshold, such as 90% (304, 305).

In order to estimate/detect whether a wind turbine is operating abnormally, it is useful to model its ideal operations. This can be achieved by predicting the thermal stress imposed on a wind turbine using rotational and mechanical data. For example, to model the thermal stress implied on the transmissional gear box which couples the mechanical rotation of the wind turbine to the electrical generator, the following temperature indicators may be used:
Gearbox temperature;
Gearbox bearing temperature;
Temperature in generator drive (low speed shaft end); and
Temperature of generator drive (high speed shaft end).

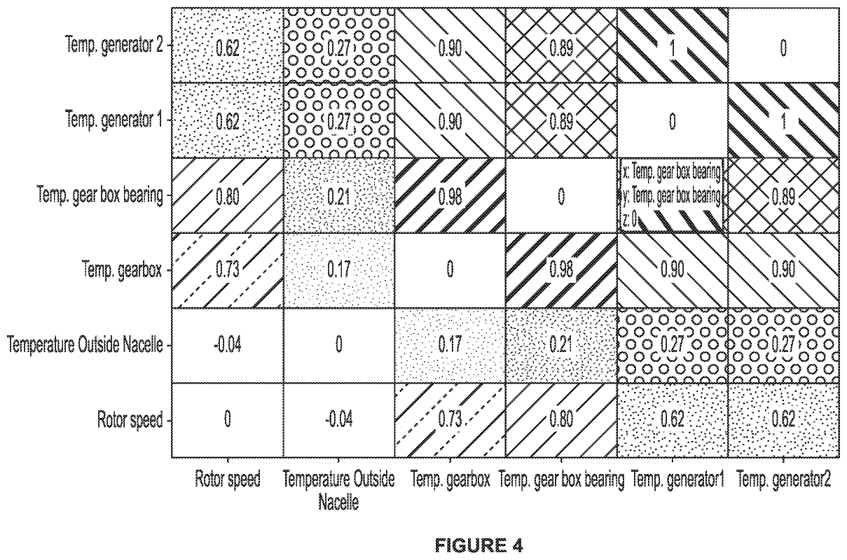

In order to build an accurate black-box machine learning model to predict each of these component temperatures, it was found that the key critical parameters that influenced these component temperatures were the rotor speed of the turbine and the ambient temperature. FIG. 4 illustrates a sample heatmap indicating the correlational nature between the various parameters.

A new index score referred to as a “severity index score” is then determined, which may be used as an indicator of the current and the historical operational status of the turbine. The severity index score may be determined as follows;
a) A deviation of a predicted gear box bearing temp from the actual temperature (for the last 8 weeks of operation) is determined by comparing the performance/trend of the temperature against a base user-referenced demarcated week when the turbine was deemed to have the best performance;
b) Statistical analysis is performed for the deviation of the gear box bearing temp with neighboring gear box bearing temperatures (for the last 8 weeks of operation);
c) Statistical analysis is performed for the deviation of the gear box bearing temp with itself over the last year/initial period after replacement of the component;
d) The total number of alarms present that are reflective of performance degradation of a gear box (for the last 8 weeks) is compared against the total number of alarms thrown by the turbine in the same period;
e) Oil analysis of gear box is performed for the last 1 year with samples taken every six (6) months. This includes analysis of the particulate matter present in the sample, metal content, color, and quality index as represented by acid no/TAN no, etc. . . . ; and
f) CMS insights on gear box based on vibration data. FFT and time domain/frequency domain analysis of the vibration signals (for the last 8 weeks of operation).
   Based on the above analysis, the final severity index of the asset is determined as ranging from 0 to 1 and is marked using a color scale from red for a high value (around 1), to amber indicating an intermediate value (around 0.75), and then to green indicating a low value (around 0). The higher the severity index score of the asset, the higher the risk of failure.

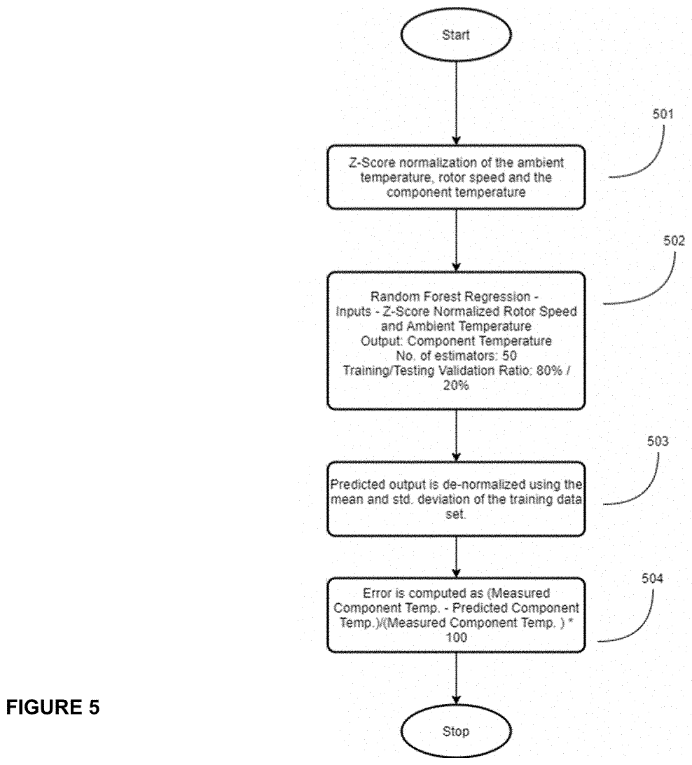

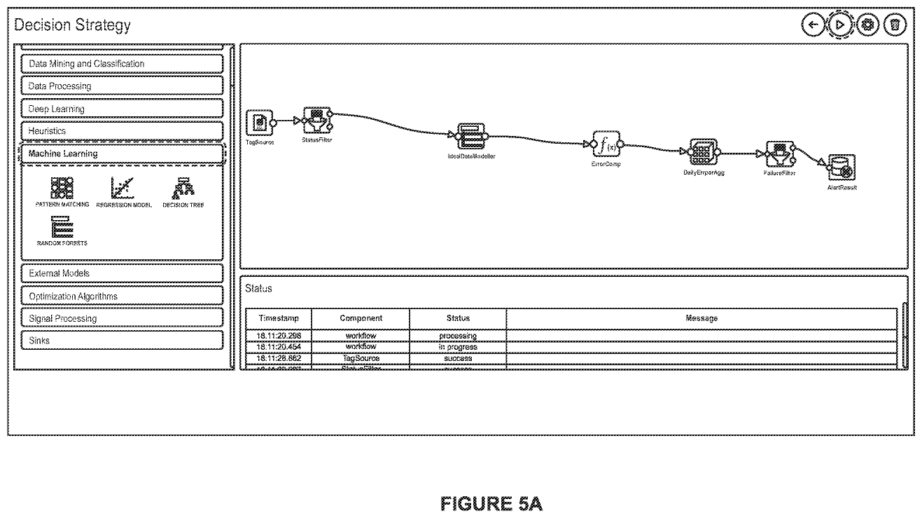

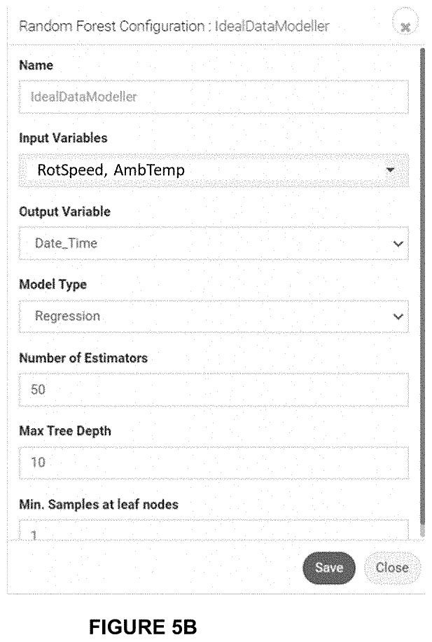

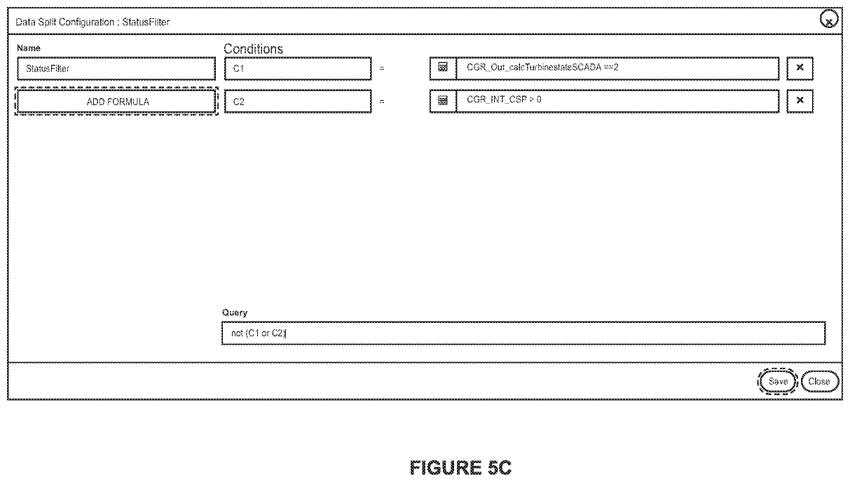

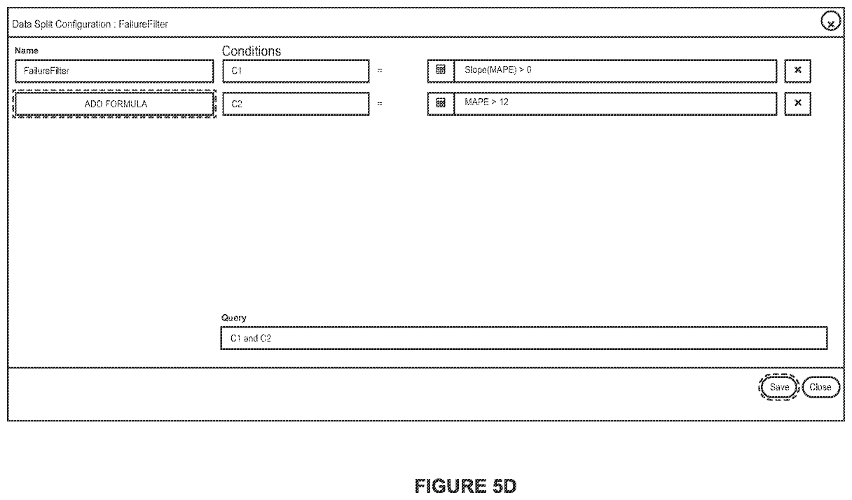

An ideal black-box representation of the asset is created by building a machine learning model such as a random forest regression to predict the desired component temperatures for a given set of values of ambient temperature and rotor speed. FIG. 5 illustrates a flow-chart which explains the use of z-score normalization (501) to normalize the input and output datasets to the same range and then training a random forest regressor (502) with around 50 estimators to predict the ideal component temperatures (503-504). FIG. 5A illustrates how the same algorithm may be performed in RETINA's Key Performance Indicator (KPI) and Decision Synchronization Platform. FIG. 5B illustrates an example of the configuration of the components/blocks used to make the algorithm. Similar models are built turbine-wise for all the component temperatures. an example of a configuration of the filters to identify derating conditions in a wind turbine. FIG. 5C illustrates an example of a configuration of the filters to identify derating conditions in a wind turbine and FIG. 5D illustrates an example of a configuration of the alert logic for determining anomalies in the operations of the asset.

Turning back to FIGS. 1, (100-8, 100-9 and 100-10) show a high level overview of how the machine learning engine works along with the other components of the RETINA remote node. The models are archived into the model repository (100-8) from where they are used for predicting the ideal temperature behavior for incoming real-time data points. The centralized engine (100-9) builds the actual model to define the ideal operational behavior of the turbines and also estimates any possible deviations of the current operations of the turbine than what is expected. An alert engine (100-10) informs the necessary stake-holders about possible eminent asset failures.

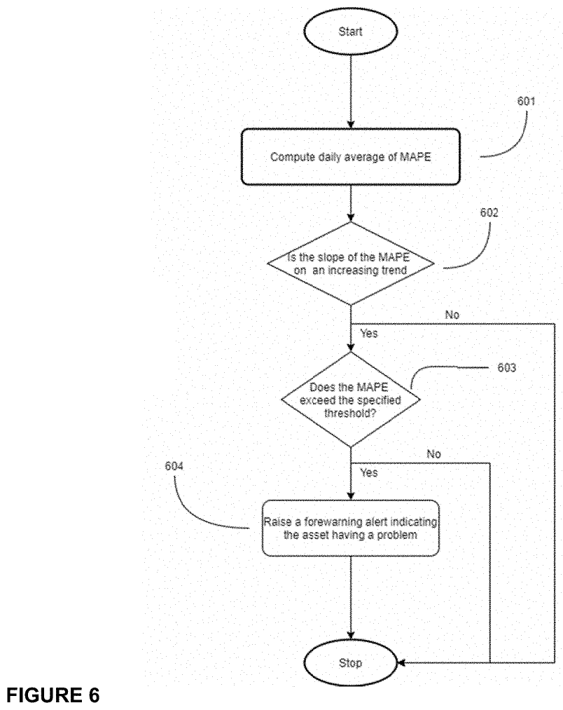

The models built to detect the expected component temperatures of a wind turbine are then used to determine the deviation of the measured component temperature parameters from the “predicted” temperatures. The deviation scores are then aggregated daily, and the average is computed. Referring to FIG. 6, the mean absolute percentage error (MAPE) (503 of FIG. 5), (601) is then estimated to have an increasing trend (602) and exceeds a minimum threshold of 5% (603). Once these conditions are satisfied, RETINA's decision synchronization engines (100-10) raise an alert to the respective stake-holders of the asset indicating potential problems with the asset.

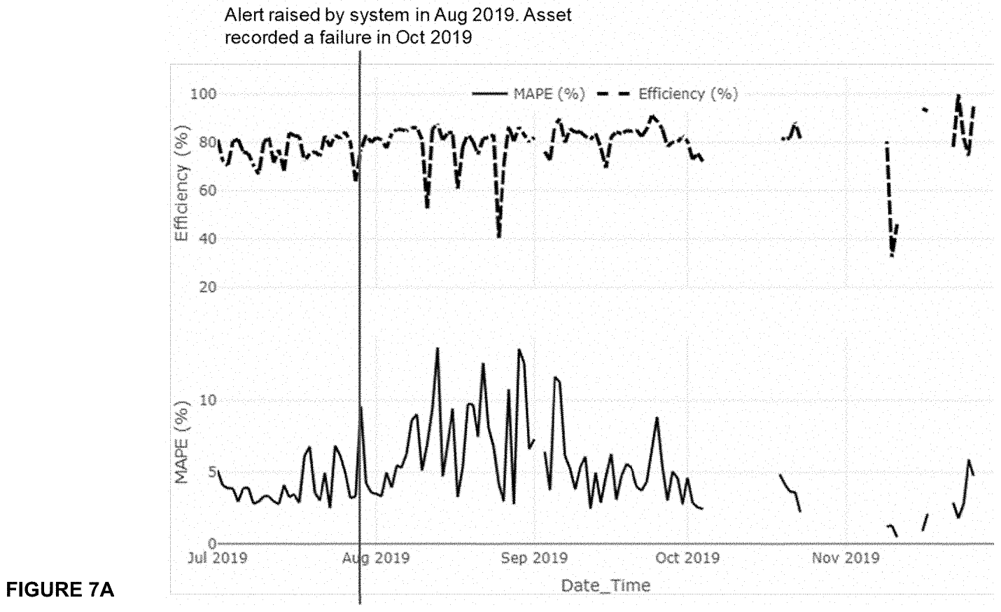

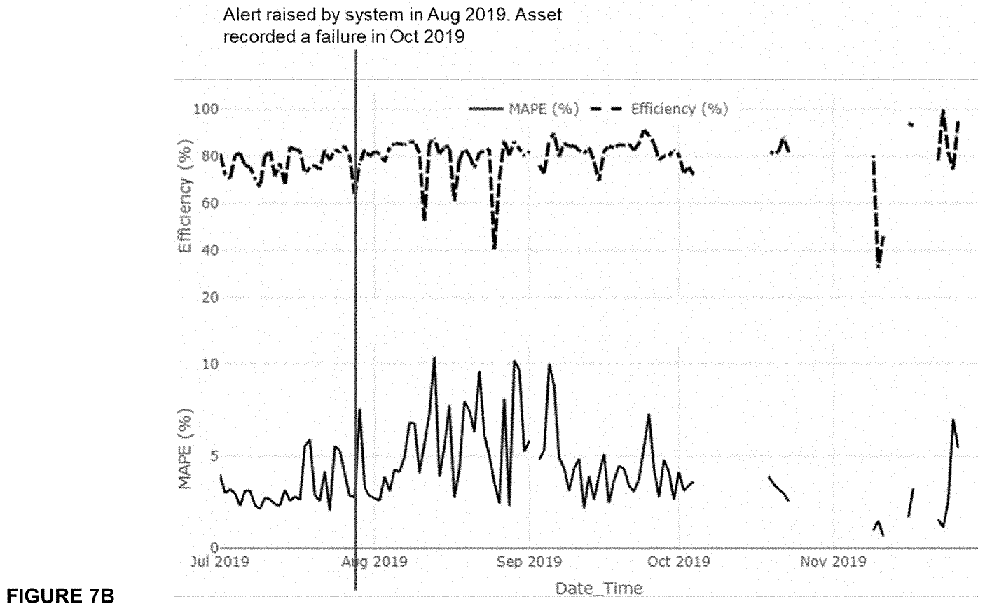

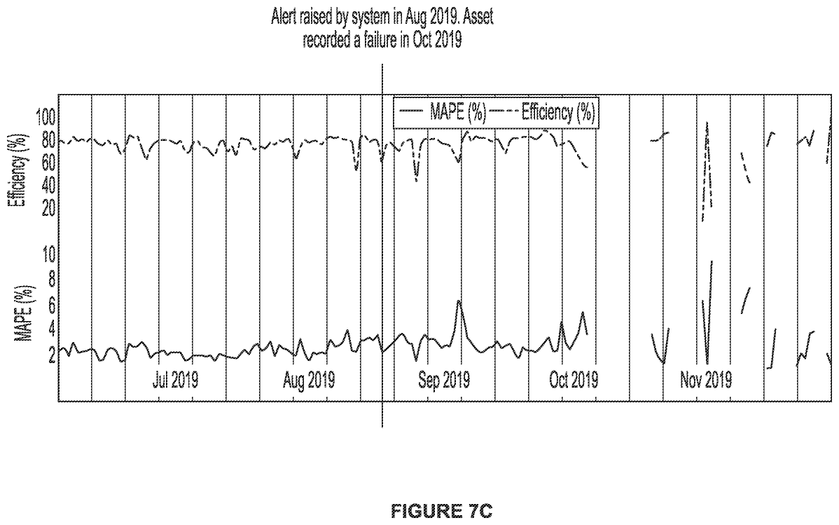

FIGS. 7A and 7B show the trend of the computed deviations for the gearbox temperature vis a vis the daily efficiency of a turbine that has had a gear box failure in history and a healthy wind turbine, respectively. FIGS. 7C show the trend of the computed deviations for the generator drive end temperature vis a vis the daily efficiency of a turbine that has had a gear box failure in history and a healthy wind turbine, respectively.

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1. A method for predicting component failure in a drive train assembly of a wind turbine, the method comprising:
acquiring data from a plurality of wind turbine sensors pertaining to one or more components of the drive train assembly;
feeding the data into one or more RETINA remote nodes;
filtering and aggregating the data into time intervals;
archiving the data in a centralized data-warehouse;
identifying and removing data points corresponding to intervals when the wind turbine was operating in a curtailed state based on the statistical parameters;
using the data to build a machine learning model configured to determine ideal temperatures of components in the drive train assembly;
comparing the ideal temperatures to actual temperatures to determine one or more temperature deviations;
using the one or more temperature deviations to determine a severity index score; and
generating an alert corresponding to a high severity index score, wherein the alert informs of a likely imminent component failure.
